(19) United States
(12) Patent Application Publication
(10) Pub. No.: US 2003/0229727 A1
(43) Pub. Date: Dec. 11, 2003

(54) Method and apparatus of virtual COM port

(75) Inventor: Chi-Pei Wang, Taichung (TW)

Correspondence Address: TROXELL LAW OFFICE PLLC, SUITE 1404, 5205 LEESBURG PIKE, FALLS CHURCH, VA, 22041, US

(73) Assignee: ENE Technology Inc.

(21) Appl. No.: 10/449,124

(22) Filed: Jun. 2, 2003

(30) Foreign Application Priority Data
Jun. 5, 2002 (TW) 091112147

(51) Int. Cl. G06F 13/10

(52) U.S. Cl. 709/321

(57) ABSTRACT

The invention adopts the virtual COM port instead of the traditional real COM port in a PC host for communicating with a micro-controller in target host. In the prior art, we need to communicate and transfer data between a host and the other one using real COM port and execute the program in the micro-controller. But the present invention uses the Virtual COM port in the PC host to replace the real one and connect to the real COM port of micro-controller in the other PC host. Then it achieves the purpose of programming in the same host including PC host and target host simultaneously.

### BACKGROUND OF THE INVENTION

1. Field of the Invention

The invention relates to a method and apparatus of virtual COM port, which adopts the virtual COM port instead of the traditional real COM port and achieves the purpose of programming in the same host including PC host and target host simultaneously.

2. Description of Prior Art

In the prior art, a 8051 micro-controller program in keyboard of personal computer desires to transfer register data or any logic signal and program to another built-in micro-controller of a target host through a real COM port. Then it needs some specific drivers of interface and a connector to link the COM ports between the source and target host. For convenient reason, the present invention downloads these signals and program to micro-controller through a virtual COM port to simulate the situation between two separate source and target hosts, but in the same host actually the program can do some execution locally without any awareness of the difference.

### SUMMARY OF THE INVENTION

The invention relates to a method and apparatus of virtual COM port, which adopts the virtual COM port instead of the traditional real COM port in a PC host for communicating with a micro-controller in target host. In brief, this invention replaces the connection mentioned in prior method between two separate hosts through a real COM ports or parallel port by a virtual COM port in one local host. Then the control host can proceed the debug program on itself by loading virtual COM port driver, it will seem like to connect the control host and another target host without any awareness of the difference between the virtual and real COM port.

### BRIEF DESCRIPTION OF THE DRAWINGS

The foregoing, as well as additional objects, features and advantages of the invention will be more readily apparent from the following detailed description, which proceeds with reference to the accompanying drawings.

FIG. 1 is a block diagram showing the functional connection in accordance with one preferred embodiment of the present invention;

FIG. 2 is a corresponding diagram of status bits of virtual COM port and micro-controller of the invention embodiment;

FIG. 3 is a flow chart of the transferring from control host into micro-controller of the invention embodiment;

FIG. 4 is a flow chart of the transferring from micro-controller into control host of the invention embodiment.

### DESCRIPTION OF THE PREFERRED EMBODIMENTS

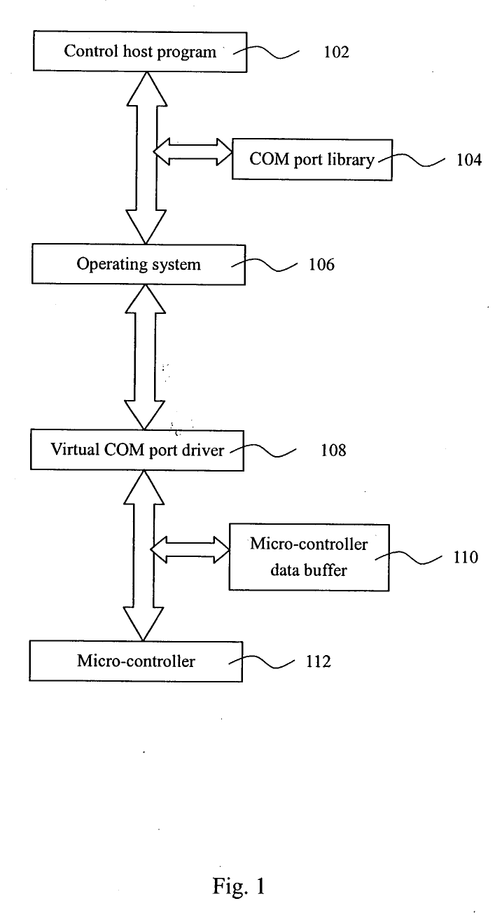

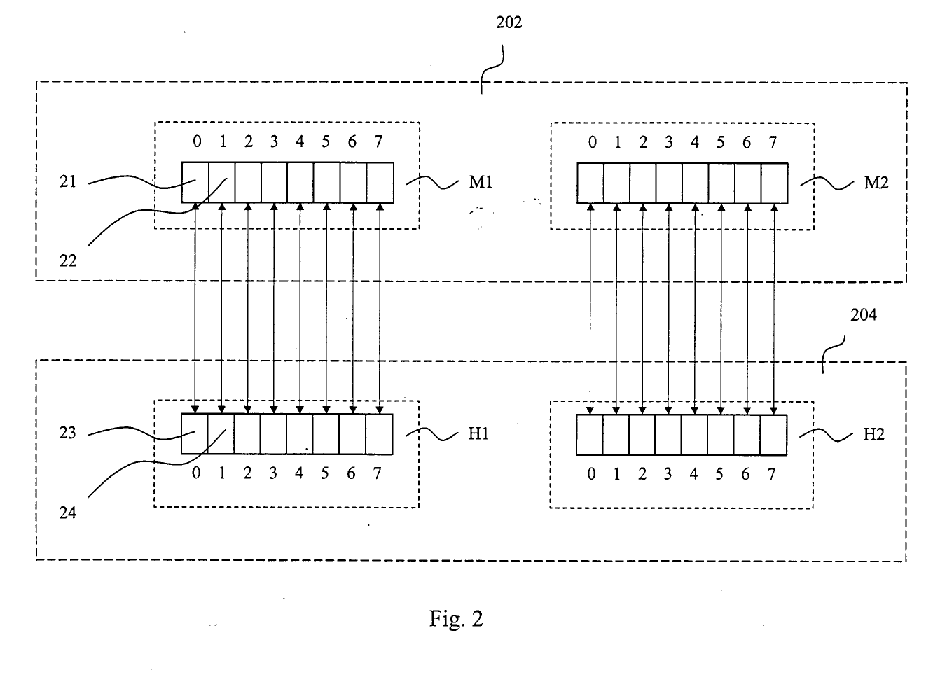

Refer to FIG. 1 for the block diagram of functional connection of the embodiment in this invention. There is a control host program 102, which adopts a standard COM port library 104 for communicating within a computer operating system 106. As the system proceeds to load a virtual COM port driver 108 into the operating system in the control host for accessing the virtual COM port, then the data of control host transfers into micro-controller data buffer 110 by the virtual COM port. Further, the control host program will access the micro-controller in the control host 112. The data mentioned above includes two interrupt signals and a byte data, and the detail description will be referred on FIG. 2. After the execution in control host, that will transfer the data including interrupt signals, status signals and program data into the register in micro-controller. The foregoing diagram of the invention is for the purpose of communication between the control host and micro-controller of embodiment of the invention.

Refer to FIG. 2, it's showing a corresponding diagram of status bits of virtual COM port and micro-controller of the invention embodiment. The data transferred from the control host into the micro-controller includes two kinds of interrupt signal and data buffer, wherein that interrupt signals are received control signal and transmitted control signal. Furthermore, the data mentioned is stored in a COM port data byte 202 and a virtual COM port data byte 204, which are located in the real COM port of the micro-controller and the virtual COM port of the control host respectively.

According to the block diagram show in FIG.2, the status bits of COM port control flag M1 (serial control register, SCON) and COM port data buffer M2 (serial data buffer, SBUF) in the real COM port data byte 202 correspond to the virtual COM port control flag H1 (virtual serial control register, PVSCON) and virtual COM port data buffer H2 (virtual serial data buffer, PVSBUF) in the virtual COM port data byte 204.

The first two bits in COM port control flag M1 are represented a COM port receive control flag 21 (SCON.RI), which is a bit status for indicating the micro-controller receiving a set of data and another COM port transmit control flag 22 (SCON.TI), which is a bit status for indicating the control host receiving a set of data. The two status bits are also indicating whether or not an interrupt event is happened in the micro-controller. When the control host accesses in the micro-controller, that will change the status of COM port control flag M1 in the micro-controller, then the control host will transfer a set of data byte into the COM port data buffer M2 of the micro-controller, at meantime, the COM port receive control flag 21 will be changed to 1. After the COM port data buffer M2 of micro-controller has received the data byte, the COM port receive control flag 21 will be changed to 0, which is the original status.

When the micro-controller transfers a set of data byte into control host, the COM port control flag M1 will be changed. That means as control host is receiving the data byte from micro-controller, the COM port transmit control flag 22 will be 1. After the transmitssion ends, the COM port transmit control flag 22 is changed to 0, which is the original status.

Further, referring to FIG. 2 for the block diagram of virtual COM port in control host, wherein the virtual COM port control flag H1 includes a virtual COM port receive control flag 23, which is a bit status for indicating the control host receiving a set of data and a virtual COM port transmit control flag 24, which is a bit status also for indicating the micro-controller receiving a set of data. These first two status signals in virtual COM port control flag H1 are by means of indicating the interrupt status signal in control host. When the micro-controller accesses to the control host, the micro-controller needs to acquire the interrupt, and set bit 1, and 0 for finishing.

The micro-controller transfers a set of data byte into the virtual COM port data buffer H2 (PVSBUF) of control host, then the virtual COM port receive control flag 23 (PVSCON.RI) will be changed to 1. When the control host receives the data byte from virtual COM port data buffer H2, the virtual COM port receive control flag 23 (PVSCON.RI) will be set to 0, that is the initial status. When the control host transfers a set of data byte to the micro-controller, the virtual COM port transmit control flag 24 (PVSCON.TI) indicates to transmission status. After the micro-controller receives the data byte, the virtual COM port transmit control flag 24 will be set to 1, for indicating the byte data transmission has finished and received by the micro-controller.

The COM port data buffer M2 of micro-controller and the virtual COM port data buffer H2 of control host are the data buffer made by a byte of register for transmitting and receiving a set of data and any other status information including the status of transferring in system respectively and these two data buffer occupy the same hardware register memory simultaneously. Meaningfully, the data written into COM port data buffer M2 will be the same with written into virtual COM port data buffer H2 and so will contrariwise.

The detail steps of embodiment of transferring from the control host into the micro-controller of this invention are described below:

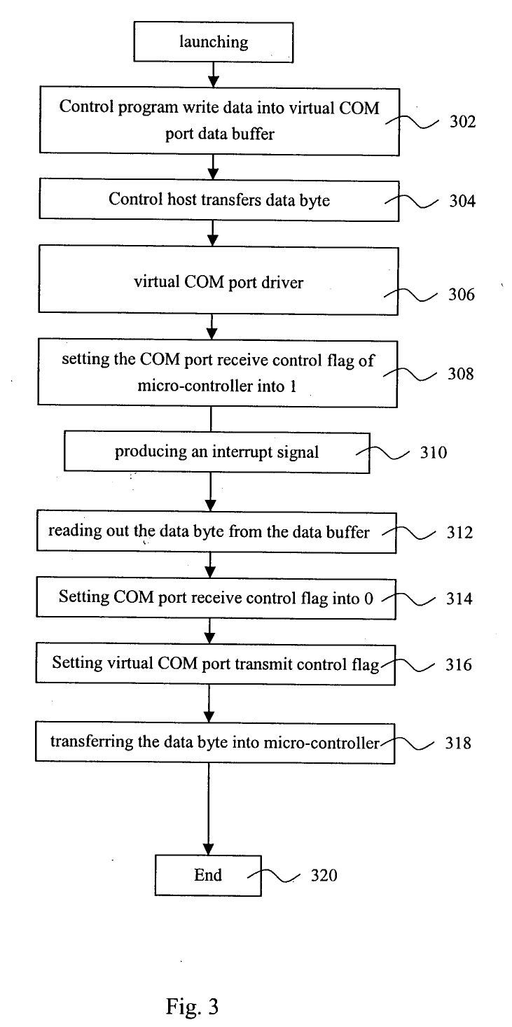

Please refer to FIG.3, which is a flow chart of the transferring from control host into micro-controller of the invention embodiment. First, a control program launching, then the control program is written into the virtual COM port data buffer (302), and the control host starts transferring data byte (304) and gets connection access with the control host. Next, a virtual COM port driver is loaded through the control host (306), at meantime, the signal written into virtual COM port data buffer will set the COM port receive control flag of the micro-controller to 1 (308), and generate a micro-controller interrupt signal (310). This status indicates the interrupt signal of micro-controller is at status on and then has permission to access the micro-controller program. When the COM port receive control flag is set to 1, the micro-controller program will be informed the COM port data buffer has received the data bytes and read out the data byte from the COM port data buffer (312). After the micro-controller reads the data byte in COM port data buffer, the COM port receive control flag will be set to 0 (314), which indicates the initial status. Then the virtual COM port transmit control flag will be set (316), and transfer the data byte into micro-controller (318). That will go on the next transferring from the control host into micro-controller (302) if any other data byte needs to be sent next.

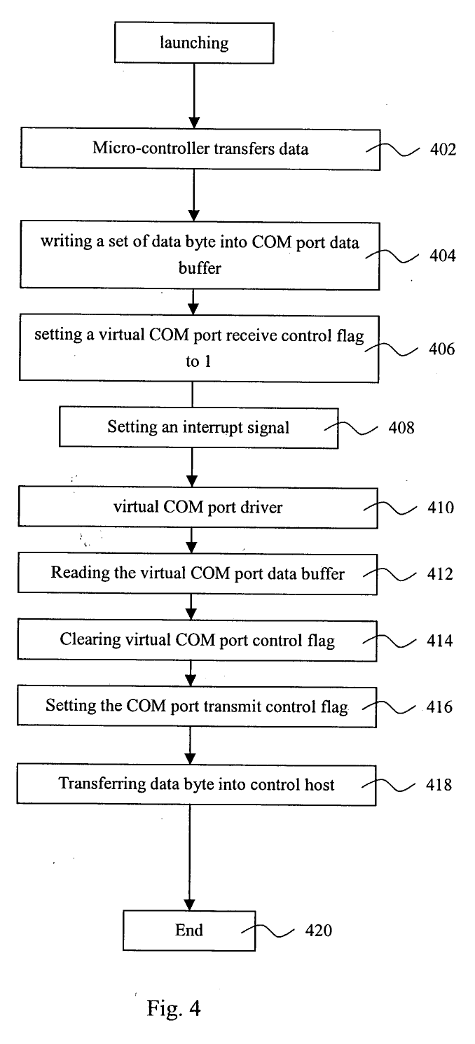

Please refer to FIG. 4, that is a flow chart of the transferring from micro-controller into control host of the invention embodiment. First, a control program launching, then the micro-controller starts transferring the data byte (402). The micro-controller program writes a set of data byte into it's own COM port data buffer (404), then sets a virtual COM port receive control flag to 1 (406), and generates an interrupt signal in the control host (408), for indicating the interrupt signal is status on. Then the micro-controller has permission to access the control host by loading the virtual COM port driver (410). When the virtual COM port receive control flag is set to 1, the control host will be informed the virtual COM port data buffer has received the data byte, and read that out (412). The data byte received by virtual COM port data buffer is the data byte written from micro-controller into COM port data buffer. At meantime, the virtual COM port receive control flag will be set to 0 (414), which is the initial status, then the COM port transmit control flag will be set for informing the micro-controller about the control host has received the data byte (416), and transfer that into the control host (418). That will go on the next transferring from the micro-controller into control host (402) if any other data byte needs to be sent next.

By means of the method and apparatus of virtual COM port set forth above, the invention of virtual COM port in the control host replaces the transferring method of traditional real COM port, thereby the invention achieves the objects of simplicity, convenience and portability.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is

1. An apparatus of virtual COM port, which is connected between a control host and a micro-controller inside, that interface includes a real and a virtual COM port, and the device comprises:
a COM port receive control flag, which is a bit status for indicating said micro-controller is receiving a set of data;
a COM port transmit control flag, which is a bit status for indicating said control host receiving a set of data;
a COM port data buffer, which is a data buffer made by a byte of register for transmitting and receiving a set of data and status information;
a virtual COM port receive control flag, which is a bit status for indicating said control host receiving a set of data;
a virtual COM port transmit control flag, which is a bit status for indicating said micro-controller receiving a set of data; and
a virtual COM port data buffer, which is a data buffer made by a byte of register for transmitting and receiving a set of data and status information;
Wherein, the present invention provides convenient and fast way via said control flag and said data buffer in a real COM port of micro-controller and said virtual COM port of control host to achieve the same purpose of communication between two hosts via traditional real COM port.

2. The apparatus of virtual COM port as recited in claim 1, wherein the two bits of said COM port receive control flag and said COM port transmit control flag are the interrupt flag said control host sets on said micro-controller.

3. The apparatus of virtual COM port as recited in claim 2, wherein whether or not said real COM port of said micro-controller receives control signal from said control host by setting 0 or 1 on said COM port receive control flag.

4. The apparatus of virtual COM port as recited in claim 3, wherein when said COM port receive control flag is set on 0 or 1, at meantime, a program in said micro-controller sets said virtual COM port transmit control flag on said control host.

5. The apparatus of virtual COM port as recited in claim 2, wherein whether or not said micro-controller transfers control signal to said control host by setting 0 or 1 on said COM port transmit control flag.

6. The apparatus of virtual COM port as recited in claim 1, wherein said COM port data buffer is the data buffer of said micro-controller, and said COM port data buffer is a register used as transferring between said micro-controller and said control host.

7. The apparatus of virtual COM port as recited in claim 1, wherein the two bits of said virtual COM port receive control flag and virtual COM port transmit control flag are the interrupt flag said micro-controller sets on said control host.

8. The apparatus of virtual COM port as recited in claim 7, wherein whether or not said virtual COM port of said control host receives control signal from said micro-controller by setting 0 or 1 on said virtual COM port receive control flag.

9. The apparatus of virtual COM port as recited in claim 8, wherein when said virtual COM port receive control flag is set on 0 or 1, at meantime, said micro-controller sets said COM port transmit control flag.

10. The apparatus of virtual COM port as recited in claim 8, wherein whether or not said control host transfers control signal to said micro-controller by setting 0 or 1 on said virtual COM port transmit control flag.

11. The apparatus of virtual COM port as recited in claim 1, wherein said virtual COM port data buffer is the data buffer of said control host, and said virtual COM port data buffer is a register used as transferring between said control host and said micro-controller.

12. The apparatus of virtual COM port as recited in claim 1, wherein said COM port data buffer and said virtual COM port data buffer occupy a memory space simultaneously.

13. A method of virtual COM port, which is a control host transferring data into a micro-controller inside, said method comprising the steps of:
writing a control host program and signal into a virtual COM port data buffer;
transferring data and starting the communication between said control host and said micro-controller;
loading a virtual COM port driver into said control host;
setting COM port receive control flag to 1;
setting an interrupt flag of said micro-controller to 1, and accessing said micro-controller;
reading out register data from a real COM port;
setting said COM port receive control flag to 0, the original status;
setting a virtual COM port transmit control flag to 1;
transferring data into said micro-controller; and
reaching the end of steps.

14. The method of virtual COM port as recited in claim 13, wherein said control host program setting all the control flags to 0 as launching of steps.

15. The method of virtual COM port as recited in claim 13, wherein reaching the end of steps as said control host setting said virtual COM port transmit control flag to 0.

16. The method of virtual COM port as recited in claim 13, wherein said control host setting said virtual COM port transmit control flag to 1, then getting the interrupt signal, and informing said control host transferring next set of data.

17. The method of virtual COM port as recited in claim 13, wherein said register data is the data written from said control host into said real COM port data buffer.

18. A method of virtual COM port, which is a micro-controller transferring data into a control host, said method comprising the steps of:
launching;
transferring data and starting the communication between said micro-controller and said control host;
writing a micro-controller program and signal into a COM port data buffer;
setting virtual COM port receive control flag to 1;
setting an interrupt flag of said control host to 1, and accessing said control host;
loading a virtual COM port driver into said control host;
reading out register data from a virtual COM port;
setting said virtual COM port receive control flag to 0, the original status;
setting a real COM port transmit control flag to 1;
transferring data from said micro-controller into said control host; and
reaching the end of steps.

19. The method of virtual COM port as recited in claim 18, wherein said micro-controller program setting all the control flags to 0 as launching of steps.

20. The method of virtual COM port as recited in claim 18, wherein reaching the end of steps as said micro-controller setting said COM port transmit control flag to 0.

21. The method of virtual COM port as recited in claim 18, wherein said micro-controller setting said COM port transmit control flag to 1, then getting the interrupt signal, and informing said micro-controller transferring next set of data.

22. The method of virtual COM port as recited in claim 18, wherein said register data is the data written from said micro-controller into said virtual COM port data buffer.
